(19) United States
(12) Patent Application Publication
(10) Pub. No.: US 2006/0094598 A1
(43) Pub. Date: May 4, 2006

(54) Medium configured to be impregnated with a liquid, and a kit including such a medium

(75) Inventor: Pascal Simon, Thiais (FR)

Correspondence Address: OLIFF & BERRIDGE, PLC, P.O. BOX 19928, ALEXANDRIA, VA, 22320, US

(73) Assignee: L'OREAL, Paris (FR)

(21) Appl. No.: 11/249,649

(22) Filed: Oct. 14, 2005

Related U.S. Application Data
(60) Provisional application No. 60/620,339, filed on Oct. 21, 2004.

(30) Foreign Application Priority Data
Oct. 14, 2004 (FR) 04 10878

(51) Int. Cl. B01J 20/22

(52) U.S. Cl. 502/401

(57) ABSTRACT

A device may include a medium configured to be impregnated with a liquid and configured to be applied to a human body. The medium may include a superabsorbent material that forms a gel on absorbing the liquid. The device may also include a receptacle including a housing in which the medium is received prior to use. A volume of the housing may be sufficient to receive both the medium and a quantity of a liquid that is sufficient for gelling the medium.

The present invention relates in particular to media that are for impregnating with a liquid and for applying to the human body, such a medium comprising a superabsorbent material that forms a gel on absorbing the liquid.

The invention also relates to devices and kits including such media.

Patent applications WO 02/03898 and WO 03/033041 disclose dressings comprising a water-absorbent material associated with a reinforcing layer or an adhesive layer.

Patent application WO 03/022317 also discloses dressings made up of water-absorbent material impregnated with a metallic solution, e.g. of a silver salt. Those dressings are made up of fibers that can be woven or non-woven and that are derived from cellulose or alginate, on their own or in a mixture.

Patent application WO 98/09590 describes dressings made up of a mixture of modified cellulose fibers and other fibers, e.g. alginate-derived fibers.

EP 0 737 463 and EP 1 350 739 describe a device arranged with two chambers, one containing a medium of the textile or sponge compress type for rehydrating, and the other containing an impregnation liquid. The two chambers are interconnected by a duct for opening during the impregnation step.

US 2002/01292269 discloses a device having two chambers, one containing a textile skin-care product and the other containing a liquid for impregnating the textile product by immersion.

There exists a need to benefit from media that are designed to absorb a liquid and to be applied to the human body, presenting appearance that is attractive for application in cosmetics, in particular, and that are practical in use.

There also exists a need to have means available that make it easy to impregnate a medium prior to applying it, and where appropriate with a predefined quantity of liquid.

There also exists a need to benefit from a medium comprising a superabsorbent material that forms a gel on absorbing a liquid, that is easy to handle, and that is easy to place on a surface of a human body to be treated.

There also exists a need to enable a medium comprising a superabsorbent material to be stored and conserved under improved conditions.

The present invention seeks to satisfy those needs in full or in part.

In one of its aspects, the present invention provides a device comprising a medium, in particular in the form of a fiber wad, for impregnating with a liquid and for being applied on the human body, the medium comprising a superabsorbent material that forms a gel on absorbing the liquid, and the device further comprising a receptacle including a housing in which the medium is received prior to use, the volume of the housing being sufficient to receive simultaneously the medium and a quantity of liquid that is sufficient to gel the medium.

The invention thus makes it easy to store the medium comprising the superabsorbent material under conditions that are sheltered and dry, and optionally also sterile, while also enabling the user to impregnate it with the desired quantity of liquid.

In addition, and in some circumstances, when a gel is formed, the medium becomes translucent or transparent, thereby presenting an attractive appearance.

In another of its aspects, the invention provides a kit comprising a medium, in particular in the form of a fiber wad for impregnating with a liquid and for applying to the human body, the wad comprising a superabsorbent material that forms a gel on absorbing liquid, and the kit further comprising a liquid for gelling the medium.

In another of its aspects, the invention also provides an applicator comprising a tube filled with at least one liquid, an applicator element for being impregnated by the liquid(s) contained in the tube, said applicator element comprising a superabsorbent material. The superabsorbent material is suitable for forming a gel on being impregnated by the liquid(s).

In yet another of its aspects, the invention provides a cosmetic treatment method comprising the following steps:

taking a medium comprising at least 80% by weight of a superabsorbent material other than polyvinylalcohol, and impregnating it with a liquid so as to form a gel on absorbing the liquid; and

putting the medium as gelled in this way in contact with a surface to be treated, in particular an uninjured surface of the body.

In the description and the claims, the term “gel” designates a soft solid or pseudo-solid obtained by combining at least two components, at least one of which is a liquid that can constitute the major fraction, e.g. 70% to 99%, preferably 90% to 99% by weight relative to the weight of the combination constituted by the medium and the liquid. The resulting gels can have excellent qualities in use. They can be discreet, and in certain embodiments they can be transparent. They can have excellent mechanical properties and be perfectly adaptable to the different shapes of the face and the body. They can be sufficiently strong, cohesive, and flexible, and they can present a certain amount of elasticity making them easy to handle, and possibly they can be sufficiently adhesive to enable them to be applied to different locations on the human body, e.g. for the purpose of releasing active agents, in particular agents that are cosmetically and/or dermatologically active.

Independently or in combination with the above, the invention also provides a medium for being impregnated with a liquid and for being applied to the human body, the medium comprising at least 80% by weight of a superabsorbent material, other than polyvinylalcohol, and forming a gel on absorbing the liquid.

Independently or in combination with the above, the invention also provides a device comprising:

a medium, in particular in the form of a fiber wad for being impregnated with a liquid and for being applied to the human body, the medium comprising a superabsorbent material that forms a gel on being impregnated with the liquid, whereupon the medium becomes translucent or transparent; and

a receptacle including a housing in which the medium is received.

Independently or in combination with the above, the invention also provides a device comprising:

a medium in sheet form for being gelled by means of a liquid and for being applied to the human body; and

a receptacle including a housing in which the medium is received, said housing presenting a volume that is sufficient to contain the quantity of liquid needed for gelling the sheet medium, the receptacle not having any reservoir containing said liquid prior to the gelling step.

Independently or in combination with the above, the invention also provides a kit comprising:

a medium for impregnated with a liquid and for being applied to the human body, the medium comprising at least 80% by weight of a superabsorbent material that forms a gel on absorbing a liquid; and

the liquid for gelling the medium.

Independently or in combination with the above, the invention also provides an applicator comprising:

a tube filled with at least one liquid; and

an applicator element for being impregnated by the liquid and comprising a superabsorbent material.

The superabsorbent material suitable for making such an applicator is advantageously a superabsorbent material selected from those listed in the description below.

Independently or in combination with the above, the invention also provides a cosmetic treatment method comprising the steps of:

pouring a liquid into the housing of a device as defined above in order to impregnate a medium; and

putting a surface that is to be treated into contact with said medium as impregnated in this way.

Superabsorbent Material

The superabsorbent material present in the medium advantageously presents very great ability to absorb a liquid, and in particular water. In particular, it may present the capacity to absorb 15 times, or even 20 times to 50 times its own weight in water, e.g. about 25 times to 30 times.

The capacity of the superabsorbent material for absorbing liquid can be determined by implementing the following method.

A sample of superabsorbent material in the powder, fiber, or bulk state, or arranged as a film or a sheet, is weighed while in the dry state (M_{D}). For example it is possible to use a non-woven square web having a side of about 1 centimeter (cm). In the context of the present method, the superabsorbent material is obtained in the “dry” state by being treated in a drying oven for about 4 hours (h) at about 50° C.

Water (or any other liquid that is to be absorbed by the material) is put into contact with the material. This can be done either by immersing the material in the liquid, or else by pouring the liquid onto the material. For example, the material may be immersed for a duration of about 1 minute (min).

The quantity of water (or liquid) is used in excess so as to saturate the material completely, for example. The excess water (or liquid) is then eliminated, e.g. by drip-drying for about 2 min, and the material saturated in liquid is weighed (M_{L}).

The difference Δ between the weight of the material when saturated in liquid and the weight of the material when dry represents the quantity of liquid that it has absorbed, which weight is compared with the dry weight of the material. The resulting value C is indicative of the capacity of the superabsorbent material to absorb the liquid, e.g. expressed in grams of liquid absorbed per gram of dry material:

$$C = \frac{Δ}{{M}_{D}} = \frac{( {M}_{L} - {M}_{D} )}{{M}_{D}}$$

Depending on the fraction of superabsorbent material it contains, the medium may absorb at least 15 times its own weight of liquid, for example, and possibly at least 20 times or 50 times its own weight of liquid, preferably 25 times to 30 times.

The absorption capacity of the medium comprising the superabsorbent material can be determined in a manner similar to the protocol described above for use with the superabsorbent material on its own.

The superabsorbent material may be selected from cellulose derivatives, alginates and derivatives thereof, in particular derivatives such as propylene glycol alginate, or salts thereof such as sodium alginate, calcium alginate, derivatives of polyacrylic acid or polymethacrylic acid, derivatives of polyacrylamide, derivatives of polyvinylpyrrolidone, derivatives of poly-vinyl ether, and mixtures thereof, amongst others.

In particular, the superabsorbent material may be selected from derivatives of chemically modified cellulose. For example it may be selected from carboxy-methyl cellulose, sodium carboxymethyl cellulose, carboxymethyl hydroxyethyl cellulose, carboxyethyl cellulose, hydroxyethyl cellulose, hydroxyethylethyl cellulose, hydroxypropyl cellulose, hydroxypropylmethyl cellulose, methyl cellulose, sodium methyl cellulose, microcrystalline cellulose, sodium cellulose sulfate, and mixtures thereof.

It may also be selected from alkyl celluloses. These polymers are obtained by grafting an alkyl residue onto one or more hydroxy groups of the cellulose polymer to form the hydroxyalkyl derivative. These alkyl residues may be selected from the following groups: stearyl, isostearyl, lauryl, myristyl, cetyl, isocetyl, cocoyl, palmityl, oleyl, linonyl, ricinolyl, behenyl, and mixtures thereof. These hydroxyalkyl cellulose derivatives may also be subjected to chemical modification, e.g. using a carboxylic residue.

The superabsorbent material may also be selected from natural polymer derivatives, such as, for example, gelatin and glucomannan and galactomannan polysaccharides extracted from seeds, vegetable fibers, fruit, seaweed, starch, plant resins, or indeed of microbial origin. For example it may be selected from agar gum, guar gum, gum tragacanth, carrageenan gum, konjac gum, locust bean gum, gellan gum, xanthan gum, and mixtures thereof.

In an embodiment of the invention, the superabsorbent material is a derivative of chemically modified cellulose, in particular carboxymethyl cellulose.

Fibers of superabsorbent material are described in the following patent applications WO 93/12275, WO 94/16746, and WO 00/01425, the contents of which are incorporated herein by reference. Carboxymethyl cellulose fibers are advantageously obtained by reacting cellulose fibers in the presence of a strong alkaline agent such as sodium hydroxide, and a carboxymethyl agent such as chloracetic acid or a salt thereof such as a sodium salt. Advantageously, the degree of cellulose fiber substitution that is obtained is about 0.1 to 0.5 carboxymethyl groups per glucose unit, or even 0.2 to 0.4 carboxymethyl groups per glucose unit. Fibers of a superabsorbent material are known, for example, under the trade names Hydrofiber Technology and sold by the supplier CONVATEC.

In an embodiment, the superabsorbent material comprises fibers. These fibers may be woven or bonded together other than by weaving, for example by using a bonding method of the kind used for making non-woven fabrics.

By way of example, the fibers may initially be combed on a carding machine. This step of orienting the fibers can condition the mechanical properties of the non-woven fiber sheet. The resulting sheet can then be consolidated by a bonding type treatment, which may take place mechanically, thermally, or chemically. For example the treatment may be needling, or tangling by means of jets of a liquid or gaseous fluid that is compatible with the nature of the fibers.

In another embodiment, the carboxymethyl reaction may be conducted on non-woven cellulose fibers manufactured prior to the carboxymethyl reaction by any known method for obtaining non-woven fabric, and in a preferred implementation by carding followed by consolidating the web by needling or by using jets of water. This implementation is preferred if it is desired to start from a non-woven fabric obtained by using jets of water, thereby making it possible to obtain structures that are more dense than those obtained by needling. Such an implementation is described in particular in patent application WO 94/16746, which is incorporated herein by reference.

As an example of a non-woven fabric that is suitable for use in implementing the invention, fabrics can be used that present a fiber density of about 50 grams per square meter (g/m²).

As an example of a needled fabric suitable for implementing the invention, mention can be made of those presenting a fiber density of about 90 g/m².

The fibers of superabsorbent material may constitute at least 80% by weight of the medium prior to it being impregnated by the liquid, or even more. For example, they may constitute at least 90%, or even at least 99% by weight of the medium prior to it being impregnated by the liquid. The medium may also be constituted essentially of such fibers. A high proportion of fibers can make it easier to obtain an effect that is visually attractive at the time of use, since the medium goes from an opaque state to a state that is translucent or transparent.

In a variant embodiment, the medium may comprise a cellulose derivative at a content of at least 0.1%, at least 10%, better 50% or 80%, and indeed substantially equal to 100%.

Active Agents

The medium may contain at least one active agent. The liquid for impregnating the medium may also optionally include an active agent. Any such active agent may be selected, for example, from those capable of acting on the skin such as cosmetically and/or dermatologically active agents.

When the medium includes an active agent, it may be incorporated in the medium in particular by means of an alternating electric field. The active agent(s) may be incorporated in particular in the powder state.

Amongst all of the active agents that can be used in the present invention, particular mention can be made of: α- or β-hydroxy acids such as lactic acid, glycolic acid, citric acid, 5-octanoylsalicyclic acid, α-hydroxydecanoic acid, α-hydroxylauric, tartaric acid, glucuronic acid, galacturonic acid, acrylic acid, α-hydroxybutyric acid, α-hydroxyisobutyric acid, malic acid, mandelic acid, phosphoric acid, pyruvic acid, lactobionic acid, and salicylic acid.

As examples of other active agents that can be used in the context of the present invention, mention can also be made of cosmetic oils such as silicone oils, triglyceride type vegetable oils, hydrocarbon oils such as parleam oil, and esters of fatty acids, and fatty alcohols, serving to confer emollient properties on the gel.

It is also possible to use anti-acne agents, such as salicylic acid or benzoyl peroxide, octopirox, dextrorotary and levorotary sulfur-containing amino acids, their salts, and their N-acetyl derivatives such as N-acetyl cysteine, or agents seeking to prevent aging of the skin and/or to improve its state, for example the above-mentioned α- and β-hydroxy acids, retinoids such as retinoic acid, retinol, and its esters, such as, for example, retinyl propionate, and retinyl acetate, or retinyl palmitate, niacinamide, allantoin, extracts of aloe, azelaic acid, bisabolol, phytic acid, collagen, or agents stimulating the formation of collagen, vitamins such as vitamin C or derivatives thereof, such as ascorbyl glucoside, vitamin E or derivatives thereof, vitamin A or derivatives thereof, vitamin F or derivatives thereof, dextrorotary and levorotary sulfur-containing amino acids and derivatives thereof as mentioned above, elastin, N-acetyl D-glucosamine, luteolin, or antioxidants such as green tea or active fractions thereof, glycerin, laponite, caffeine, essential aromatic oils, coloring agents, free-radical scavengers, moisturizers, depigmenting agents, agents for improving the color of the skin such as artificial-tanning agents of the dihydroxyacetone or tyrosin ester type, liporegulators, softeners, anti-wrinkle agents, keratolytic agents, fresheners, deodorants, anesthetics, nourishing agents, and mixtures thereof. It is also possible to use bleaching agents such as kojic acid, ascorbyl phosphates, ascorbyl glucosides, ascorbic acid, and mixtures thereof.

It is also possible to use active agents for improving the condition of the skin, such as moisturizers or agents serving to improve the natural lipid barrier, such as ceramides, cholesterol sulfates, and/or fatty acids, and mixtures thereof. It is also possible to use enzymes that have activity on the skin, such as proteases, lipases, cerebrosidases, and/or melanases, and mixtures thereof.

As other examples of agents that can be suitable for implementing the present invention there are agents for pain-killing, anesthetics, antibacterial agents, anti-yeast agents, antifungal agents, antiviral agents, anti-dermititis agents, anti-pruritic agents, anti-emetics, vascular protectors, agents against motion sickness, anti-irritants, anti-inflammatory agents, immunomodulators, anti-hyperkeratolytic agents, agents for treating dry skin, antiperspirants, anti-psoriatic agents, antidandruff agents, anti-aging agents, anti-asthmatic agents and bronchodilators, sunscreen agents, antihistamines, healing agents, corticosteroids, tanning agents, and mixtures thereof.

The content of active agents in the medium and/or in the liquid may be adjusted as a function of the region being treated and the intended purpose. For example, it may be greater than 100%, e.g. about 150% by weight of active agent relative to the weight of the medium without the active agent.

Liquids

The liquid used for impregnating the medium is, for example, mostly constituted by water, in a quantity lying in the range 10% to 100% of the composition of the liquid, preferably in the range 50% to 100%, more preferably in the range 90% to 100%. By way of example, it may be water, an aqueous solution, a hydroalcohol or an alcohol lotion, or an emulsion. When the user uses water to impregnate the medium, it may be, for example: tap water, sea water, mineral water, or spring water.

The viscosity of the liquid as measured using a Brookfield Digital viscosmeter, model DV II, measuring body No. 3 may lie in the range 100 millipascal seconds (mPa·s) to 500,000 mPa·s, preferably in the range 500 mPa·s to 100,000 mPa·s, more preferably in the range 500 mPa·s to 20,000 mPa·s, and most preferably in the range 500 mPa·s to 3,000 mPa·s.

In an embodiment of the invention, prior to being impregnated with a liquid, the medium includes one or more active agents, e.g. selected from those mentioned above. The liquid used for gelling the medium then need not have any active agents and can be selected so as to dissolve the active agent present in the medium.

In another embodiment of the invention, both the medium and the liquid for impregnating it contain respective active agents, e.g. selected from the active agents mentioned above. This embodiment is particularly advantageous when associating active agents which, in combination, are unstable over time. Thus, by separating the active agents in the medium and in the liquid for gelling the medium, their own conservation is improved.

In yet another embodiment of the invention, the medium does not have any active agent, in which case the liquid for impregnating the medium may include an active agent, where appropriate.

Forms of the Medium

The medium comprising a superabsorbent material may be arranged in the form of at least one sheet, particularly when it comprises or is essentially constituted by fibers, e.g. of carboxymethyl cellulose or one of the other superabsorbent materials mentioned above.

In an embodiment of the invention, the medium is in the form of a sheet comprising non-woven fibers of superabsorbent material.

In another embodiment of the invention, the medium may be in the form of a sheet comprising woven fibers.

In a variant embodiment, the medium comprises a powder and where appropriate a net. By way of example, the net can contribute to providing the medium with cohesion after it has been impregnated with the liquid and the superabsorbent material has transformed into a gel.

Where appropriate, the medium may present a multilayer structure, in which at least one layer comprises a superabsorbent material. For example, the various layers may include different active agents. Some or all of the various layers may comprise a superabsorbent material. In particular, one of the layers may have no superabsorbent material, e.g. it may comprise fibers, thread, a film, a net, or a filler that is inert relative to the liquid and that absorbs substantially no liquid. By way of example, the medium may include reinforcement or a support suitable for causing the gel that is obtained by impregnating the medium to be stronger and better at withstanding disintegration.

By way of example, if present, the support may also comprise a layer of cellulose fibers, or a layer of synthetic fibers such as polyamide fibers, polyester fibers, or polyethylene fibers.

After absorbing the liquid, the medium may present a reduction in its outside surface area. This reduction may be at least 10%, and may be as much as 40% of the initial area.

The medium may increase in thickness by at least 50%, and in particular by at least 150% of its initial thickness.

After being impregnated with the liquid, the medium advantageously presents a structure that is uniform and stable over the length of time needed for its use. This length of time may lie in the range a few seconds (e.g. about 10 s) to a few hours (e.g. about 4 h to 8 h).

After being impregnated with the liquid, the medium may advantageously become transparent or translucent.

After being impregnated with the liquid, the medium may be substantially not elastically deformable.

The medium may be in the form of a cut sheet, for example in the form of a mask or a patch for applying to the face, or to any other part of the body to be treated.

The medium may also include a cavity in which at least a portion of the human body can be engaged. For example the medium may be in the form of a glove, in particular a mitt, thus serving to treat a hand, or enabling it to be used as a glove for treating other parts of the body.

Advantageously, the medium may be presented in a variety of shapes, each adapted to some particular use. Thus, it may be presented in the form of a finger glove, a cap for putting over the head in order to treat the hair, or the scalp, or a bag or pouch for placing around an ear.

The cavity may be made from a single sheet that is folded in half, or from a plurality of sheets that are assembled together by heat-sealing, adhesive, or stitching, for example.

When the medium is for applying on at least a part of the face, it may include at least one opening, e.g. for the eyes, for the nose, and/or for the mouth.

Receptacle and Closure Member

The device advantageously includes a closure member for closing the housing, in particular in airtight manner.

The closure member may comprise a film which may be fastened to the receptacle by adhesive or by heat-sealing, for example.

By way of example, the film may be a film of plastics material and/or of metal. By way of example, the film may be a film of PET or of a polyolefin, optionally covered in a metal, e.g. aluminum.

At least a portion of the film disposed at the periphery of the device need not adhere to the receptacle, thereby enabling the film to be grasped for the purpose of removing it.

The receptacle may comprise a plate.

The housing may present a bottom wall that is plane and a side wall that is inclined, e.g. flaring away from the bottom wall.

By way of example, the side wall is arranged so as to follow the outline of the medium placed in the housing.

The housing may advantageously present a depth greater than the maximum thickness of the medium. For example, this depth may lie in the range 2 millimeters (mm) to 6 mm.

By way of example, the housing may define a volume lying in the range 1 milliliter (mL) to 50 mL, in particular in the range 3 mL to 30 mL, or 4 mL to 20 mL, as a function of the medium that is to be impregnated.

The housing containing the medium may be the sole housing in the receptacle.

When the receptacle has a plurality of housings, each containing a respective medium, the media may be impregnated with or may contain different respective active agents. Under such circumstances, the user may select the medium as a function of the treatment that is to be performed, for example, or may use a plurality of media having different shapes in combination with different liquids for simultaneously treating different zones of the face or the body.

The receptacle may be made at least in part out of a material that is impermeable to the liquid, for example a plastics material and/or a metal. For example the metal may be aluminum. As examples of the plastics material, mention can be made of thermoplastics, e.g. polyolefins, in particular polyethylene or polypropylene. The receptacle may be obtained by thermoforming.

The receptacle is advantageously constituted by a plastics material, that is at least partially transparent or translucent.

The device may include a plurality of media. In such a configuration, at least two of the media may contain different active agents. These media may be contained in different housings of the receptacle, as mentioned above.

In a variant embodiment, the media may be disposed in different housings belonging to different receptacles, which may be interconnected via breakable zones, for example.

Kits

Independently or in combination with the above, the invention also provides a kit comprising:

a medium, in particular a medium as defined above, for being impregnated with a liquid, and for being applied to the human body, the medium comprising a superabsorbent material that forms a gel on absorbing liquid; and

the liquid for impregnating the medium.

Independently or in combination with the above, the invention also provides a kit comprising:

a medium for being impregnated with a liquid and for being applied to the human body, the medium comprising a superabsorbent material that forms a gel on absorbing the liquid; and

a device comprising:

a receptacle having a housing for receiving said medium;

a closure member for the housing; and

the liquid for impregnating the medium.

The kit may include a plurality of devices. The devices may be contained independently of one another in common packaging, or they may be associated with one another at least in pairs by means of breakable zones, for example.

When the kit includes a plurality of media, at least two of the media may include different active agents.

The kit may also include a plurality of liquids. These liquids may be different from one another.

The or each liquid for use in such a kit may be packaged in a single-use container.

### EXAMPLES

The invention can be better understood on reading the following detailed description of non-limiting embodiments thereof, and on examining the accompanying drawings, in which:

FIG. 1 is a diagrammatic perspective view of a device constituting an embodiment of the invention;

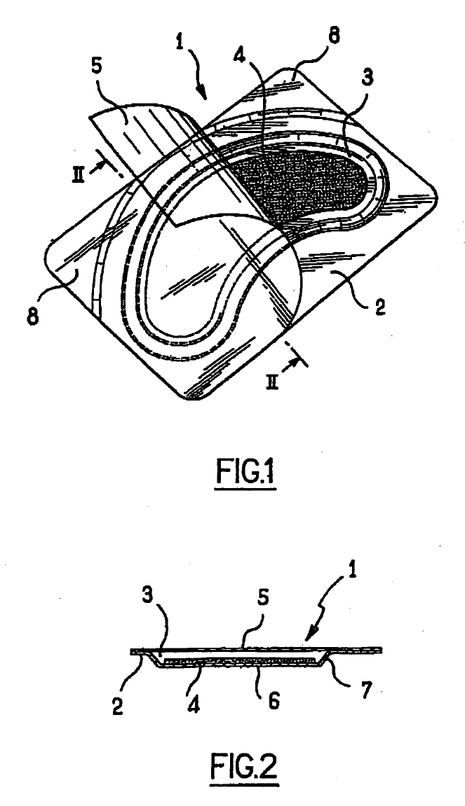

FIG. 2 is a diagrammatic and fragmentary cross-section on II-II of FIG. 1;

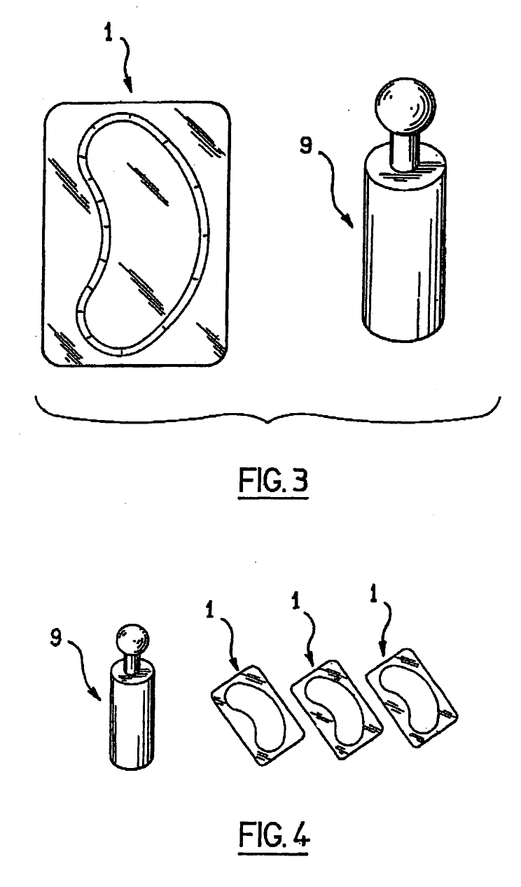

FIGS. 3 to 5 show different examples of kits made in accordance with the invention;

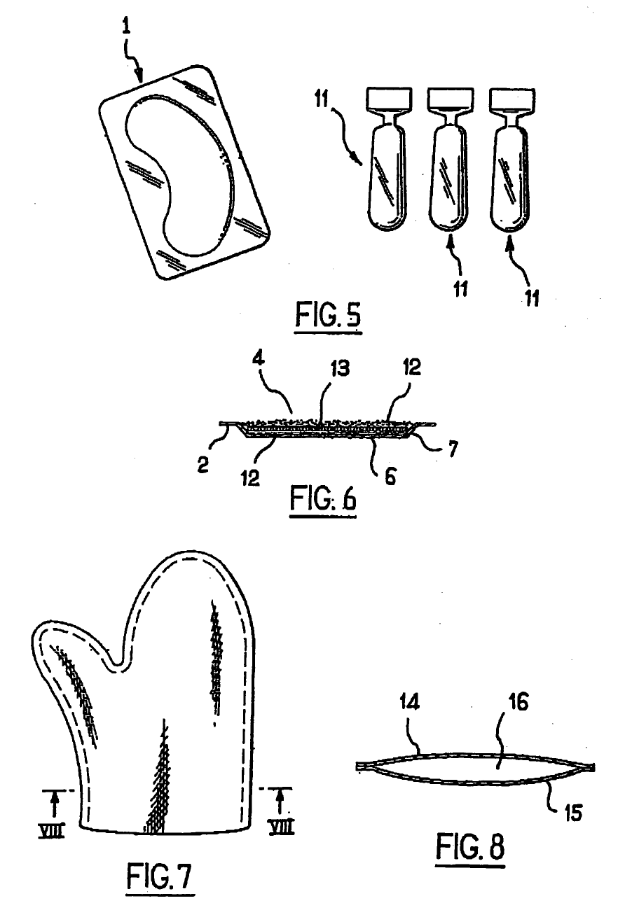

FIG. 6 is a view analogous to FIG. 2 showing a variant embodiment of the invention;

FIG. 7 is a face view of a variant embodiment of a medium in accordance with the invention;

FIG. 8 is a cross-section on VIII-VIII of FIG. 7;

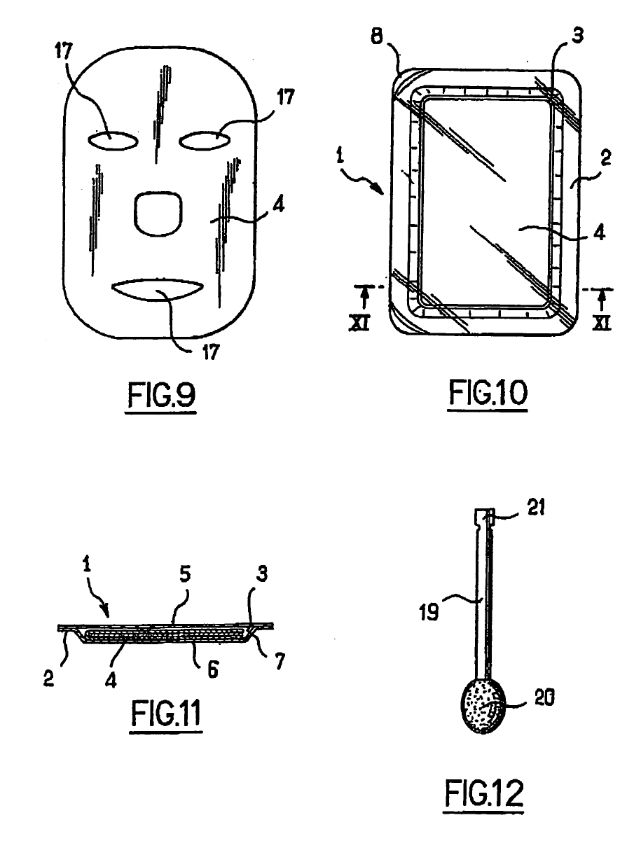

FIG. 9 is a front view of a variant embodiment of a medium in accordance with the invention;

FIG. 10 is a front view of a variant embodiment of a device in accordance with the invention, containing the medium shown in FIG. 9;

FIG. 11 is a cross-section on XI-XI of FIG. 10; and

FIG. 12 is a diagrammatic elevation view of an applicator constituting another embodiment of the invention.

FIGS. 1 and 2 show an example of a device 1 made in accordance with the invention that comprises a receptacle 2 providing a housing 3 in which there is received a medium 4 for applying to the human body, the receptacle 2 being closed in leaktight manner prior to use by a closure member 5, which in the example shown is in the form of a peel-off film.

The housing 3 presents a bottom wall 6 that is substantially plane, and a side wall 7 that fits substantially around the outline of the medium 4 and that flares away from the bottom wall 6.

The film 5 is secured to the receptacle 2 by heat-sealing or hot-melt adhesive, except for at least one portion 8 overlying a lightly setback region of the receptacle, thus enabling the user to take hold of a corner of the film 5 in order to remove it.

By way of example, the film 5 is a film of plastics material or of metal, or it is a composite film comprising one or more plastics materials and/or one more layers of metal.

In the example described, the receptacle 2 is in the form of a plate made by thermoforming a sheet of transparent plastics material, e.g. polyolefin.

The volume of the housing 3 is sufficient to contain not only the medium 4, but also a quantity of a liquid for impregnating the medium 4, said quantity being sufficient to enable the medium to be used for the intended purpose.

For example, the volume of the housing 3 is at least twice the volume occupied by the medium 4 therein. In the example shown, the depth of the housing 3 is about 2 mm or 3 mm.

To use the device 1, the user proceeds by removing the closure member 5, and then pours the liquid into the housing 3, with the housing 3 possibly being filled until it covers the medium 4 completely or until it is about to overflow from the housing 3, or indeed in a variant that is not shown, until it reaches a predefined level marked by a line on the receptacle, for example.

When the liquid is contained in a container, measuring-out means may be provided, where appropriate. The liquid may also be contained in a single-use container, with the entire content of the container then being poured into the housing 3.

In accordance with the invention, the medium 4 comprises at least one superabsorbent material that transforms into a gel, as mentioned above, and where appropriate one or more active agents, in particular agents selected from those listed above. Specifically, the medium 4 may be in the form of a fiber wad.

In the example shown in FIGS. 1 and 2, the medium 4 is intended to exert an anti-wrinkle action on the outline of the eye, for example, and it is constituted by a needled wad based on Hydrofiber fibers from CONVATEC weighing 90 g/m², and cut out as a bean-shaped patch that is 6.5 cm long at its greatest length and 2.3 cm wide at its greatest width. It may be impregnated immediately prior to being applied to the outline of the eye with about 3 mL to 4 mL of the following composition: water qsp 100, extract of mint leaves in aqueous solution 1%, encapsulated retinyl palmitate 1%, laponite 0.5%, preservatives 0.3%, fragrance 0.1% (the proportions being by weight).

FIG. 3 shows a kit comprising a device 1 as described above together with a container 9 containing the liquid for impregnating the medium 4, where the liquid can be one of those listed above, for example, possibly containing one or more cosmetically and/or dermatologically active agents.

The content of the container 9 may be adapted for a single use, or in a variant, it may be adapted for a plurality of uses.

In the variant shown in FIG. 4, a container 9 is associated with a plurality of devices 1, e.g. to enable a plurality of successive uses.

The media 4 contained in the devices 1 may be identical, or in a variant they may contain different active agents so as to enable the user to select a desired device 1 from amongst several, depending on the active agents they contain and on the treatment that is to be performed.

In the variant embodiment of FIG. 5, the kit comprises not only the device 1, but a plurality of containers 11 containing different respective liquids, e.g. liquids containing specific active agents, thus enabling the user to select a container 11 as a function of the active agents it contains, for example, depending on the treatment that is to be performed.

By way of example, the containers 11 are single-use cartridges each having a break-off end, as shown. Naturally, the containers 11 could be of some other form, without that going beyond the ambit of the present invention, for example they could be ampules.

The content of a container 9 or a container 11 lies, for example, in the range 1 mL to 50 mL, in particular in the range 3 mL to 30 mL, or indeed 4 mL to 20 mL.

In a variant that is not shown, the kit comprises a plurality of devices 1 and a plurality of containers 9 or 11, the devices being identical or different, and the containers being identical or different. For example, the kit may comprise a plurality of devices containing different active agents and a plurality of containers also containing different active agents, and the user can make any desired combination of active agents.

In the above examples, the medium 4 may be in the form of a patch comprising fibers of a gel-forming superabsorbent material, but it could also be in some other form.

For example, FIG. 6 shows a variant embodiment in which the medium 4 comprises a powder 12 of gel-forming superabsorbent material with a net 13 placed therein.

On being impregnated with the liquid, the powder 12 gels and the presence of the net provides the medium 4 with cohesion and also makes it easier to handle.

In the example of FIG. 8, the medium presents a hollow structure comprising an assembly of two sheets 14 and 15 defining between them a cavity 16 in which a part of the body can be engaged, e.g. the hand.

By way of example, the glove shown in FIG. 7 can be intended either for treating the hand or else for enabling the user to treat any other region of the body using the medium like a washcloth.

By way of example, a glove for applying a self-tanning agent is made for example out of a non-woven fabric bonded together by jets of water and based on Hydrofiber fibers from CONVATEC weighing 50 g/m². It is initially impregnated with dihydroxyacetone powder at 150% by weight of dihydroxyacetone per 100 g of medium by any suitable means, in particular and in preferred manner by impregnation by means of an alternating electric field.

Immediately before being applied to the body, it can be impregnated with about 50 mL of water. It can also be used directly on wet skin without itself being wetted, preferably massaging the skin uniformly so as to apply coloring uniformly.

When the medium 4 is in the form of a hollow structure or a mask having openings 17 as shown in FIG. 9, it can be packaged in a plate 2 like the embodiment of FIGS. 1 and 2 in a rolled-up or folded state.

By way of example, the mask of FIG. 9 for exercising an anti-wrinkle action and encouraging a radiant complexion, can be constituted, for example, by a needled wad of Hydrofiber fibers from CONVATEC weighing 90 g/m², cut to the shape of a face being 20 cm at its greatest height and 23 cm at its greatest width. It can initially be impregnated with ascorbic acid in powder form to 150% by weight of vitamin C per 100 g of medium by any appropriate means, in particular and preferably by being impregnated using an alternating electric field. Immediately prior to being applied to the face, the mask can be impregnated with about 20 mL to 30 mL of the following composition: water qsp 100, allantoin 1%, glycerin 3%, preservatives 0.3%, fragrance 0.1% (the proportions being by weight).

The use of fibers made of a superabsorbent material capable of gelling in the presence of a liquid can be advantageous not only for making media 4 in sheet form for application to the human body, but also for making applicator elements, such as the element shown in FIG. 12.

This figure shows an applicator containing internally at least one liquid, and at the end of a tube an applicator element 20 that can be impregnated by the liquid(s) contained in the tube 19 on being used.

By way of example, apart from the nature of the applicator element, the applicator shown in FIG. 12 can be identical to any one of those described in the following French patent applications: FR 2 845 005, FR 2 844 986, FR 2 844 973, FR 2 845 069, and FR 2 844 974, the contents of which are incorporated in the present application by reference.

By way of example, at its end remote from the applicator element 20, the tube 19 has a break-off endpiece 21 which, on being broken off, allows air to enter into the tube and the liquid(s) contained inside the tube to flow towards the applicator element 20.

Where appropriate, the liquid(s) contained in the tube 19 and the applicator element 20 can be separated by a liquid plug, e.g. of silicone.

In use, the user breaks the break-off portion 21 and the liquid(s) contained in the tube 19 reach the applicator element 20.

Because of the presence of the superabsorbent material therein, the applicator element 20 can absorb all of the liquid(s) contained in the tube 19 and the risk of any of the liquid impregnating the applicator element 20 dripping off is small.

By way of example, the liquid(s) contained in the tube 19 may include at least one of the above-mentioned active agents.

Making the applicator element 20 out of fibers of a gel-forming superabsorbent material, such as one of those listed above, is particularly advantageous when the liquid(s) for impregnating the endpiece is/are of low viscosity.

The applicator element 20 may be essentially constituted by fibers of the gel-forming superabsorbent material, where appropriate.

In a variant, the applicator element 20 does not comprise fibers of superabsorbent material, but instead a powder of said material, which powder can be mixed with fibers of cotton or of some other material or can be incorporated in a cellular structure or a felt, for example.

The volume of liquid contained in the tube 19 lies for example in the range 0.01 mL to 5 mL, and in particular in the range 0.5 mL to 1 ml.

Throughout the description, including in the claims, the term “comprising a” should be understood as being synonymous with “comprising at least one” unless specified to the contrary, and the term “in the range” should be understood as including the end values of the range.

1. A device (1) comprising:
a medium (4), in particular in the form of a wad of fiber, for being impregnated with a liquid and for being applied to the human body, the medium comprising a superabsorbent material that forms a gel on absorbing the liquid; and
a receptacle (2) having a housing (3) in which the medium is received prior to use, the volume of the housing (3) being sufficient to receive both the medium and a quantity of liquid that is sufficient for gelling the medium (4).

2. A device according to claim 1, characterized in that the superabsorbent material (4) comprises fibers.

3. A device according to claim 2, characterized in that the fibers are bonded together other than by weaving.

4. A device according to claim 2, characterized in that the fibers are woven.

5. A device according to any one of claims 2 to 4, characterized in that the fibers of superabsorbent material constitute at least 80% by weight of the medium (4) prior to being impregnated with the liquid.

6. A device according to any one of claims 2 to 4, characterized in that the fibers of superabsorbent material constitute at least 90% by weight of the medium (4) prior to being impregnated with the liquid.

7. A device according to any one of claims 2 to 4, characterized in that the fibers of superabsorbent material constitute at least 99% by weight of the medium (4) prior to being impregnated with the liquid.

8. A device according to any preceding claim, characterized in that the superabsorbent material is selected from cellulose derivatives, alginates and derivatives thereof, derivatives of polyacrylic acid or of polymethacrylic acid, derivatives of polyacrylamide, derivatives of polyvinylpyrrolidone, derivatives of poly-vinyl ether, gums, and mixtures thereof.

9. A device according to the preceding claim, characterized in that the medium (4) comprises a derivative of cellulose constituting at least 0.1%, in particular at least 10%, 50% or 80%, or being substantially equal to 100%.

10. A device according to claim 9, characterized in that the cellulose derivative comprises carboxymethyl cellulose.

11. A device according to any preceding claim, characterized in that the medium includes at least one cosmetically and/or dermatologically active agent.

12. A device according to claim 11, characterized in that the medium includes a self-tanning agent.

13. A device according to claim 11, characterized in that the medium includes an anti-wrinkle agent.

14. A device according to claim 11, characterized in that the medium includes vitamin C.

15. A device according to any one of claims 11 to 14, characterized in that the medium includes an active agent in powder form.

16. A device according to claim 15, characterized in that the active agent in powder form is incorporated in the medium by an alternating electric field.

17. A device according to any one of claims 11 to 16, characterized in that the active agent is present at a content by weight relative to the total weight of the medium without the active agent that is greater than or equal to 100%, and in particular that is about 150%.

18. A device according to any preceding claim, characterized in that the medium (4) is arranged in the form of at least one sheet.

19. A device according to claim 1, characterized in that the medium (4) comprises a powder (12) and a net (13) in contact therewith.

20. A device according to any preceding claim, characterized in that the medium (4) presents a multilayer structure in which at least one layer comprises the superabsorbent material.

21. A device according to any preceding claim, characterized in that the medium (4) further includes a material that substantially does not absorb the liquid.

22. A device according to any preceding claim, characterized in that, after absorbing the liquid, the medium (4) has its outside surface area decreased by at least 10%.

23. A device according to any preceding claim, characterized in that, after absorbing the liquid, the medium presents an increase in thickness of at least 50%.

24. A device according to any preceding claim, characterized in that the medium presents cohesion, at least after it has been impregnated by the liquid.

25. A device according to any preceding claim, characterized in that the medium (4) becomes transparent or translucent after being impregnated by the liquid.

26. A device according to any preceding claim, characterized in that, after being impregnated by the liquid, the medium is substantially not elastically deformable.

27. A device according to any preceding claim, characterized in that the medium (4) includes a cavity (16) in which at least a portion of the human body can be engaged, the medium being in particular in the form of a glove, a finger glove, a mobcap, a balaclava, a slipper, a bag or a pouch for placing over an ear.

28. A device according to any one of claims 1 to 25, characterized in that the medium is in the form of a patch or a mask.

29. A device according to any preceding claim, characterized in that it includes a closure member (5) for closing the receptacle (2).

30. A device according to claim 29, characterized in that the closure member (5) closes the housing (3) in leaktight manner.

31. A device according to claim 29 or claim 30, characterized in that the closure member (5) comprises a film.

32. A device according to claim 31, characterized in that the film (5) is secured to the receptacle by adhesive or by heat-sealing.

33. A device according to any preceding claim, characterized in that the receptacle (2) comprises a plate.

34. A device according to any preceding claim, characterized in that the housing (3) presents a bottom wall (6) that is substantially plane.

35. A device according to the preceding claim, characterized in that the housing presents a sloping side wall (7) flaring away from the bottom wall (6).

36. A device according to the preceding claim, characterized in that the side wall (7) substantially follows the outline of the medium (4) disposed in the housing (3).

37. A device according to any preceding claim, characterized in that the depth of the housing (3) is greater than the maximum thickness of the medium.

38. A device according to any preceding claim, characterized in that the depth of the housing (3) lies in the range 2 mm to 6 mm.

39. A device according to any preceding claim, characterized in that the housing (3) containing the medium is the sole housing in the receptacle (2).

40. A device according to any preceding claim, characterized in that the receptacle (2) is at least partially transparent.

41. A device according to any preceding claim, characterized in that the receptacle (2) is obtained by thermoforming.

42. A device (1) comprising:
a medium (4) in particular in the form of a fiber wad, for being impregnated with a liquid and being applied to the human body, the medium comprising a superabsorbent material that forms a gel on being impregnated with the liquid, the medium (4) then becoming translucent or transparent; and
a receptacle (2) having a housing (3) in which the medium is received.

43. A device (1) comprising:
a medium (4) in sheet form that is for being gelled by means of a liquid and for application to the human body; and
a receptacle (2) including a housing (3) in which the medium (4) is received, the housing (3) presenting a volume that is sufficient to contain the quantity of liquid needed to gel the sheet medium, the receptacle (2) not having any reservoir containing said liquid prior to the gelling step.

44. A device according to any preceding claim, characterized in that it includes a plurality of media (4).

45. A device according to the preceding claim, characterized in that at least two media contain different active agents.

46. A device according to claim 44 or claim 45, characterized in that the media (4) are contained in different housings (3) of the receptacle (2).

47. A device according to claim 44 or claim 45, characterized in that the media (4) are contained in different housings (3) belonging to respective different receptacles (2).

48. A device according to the preceding claim, characterized in that the receptacles (2) are interconnected in pairs by breakable zones.

49. A kit comprising:
a device (1) as defined in any preceding claim; and
a liquid for impregnating the medium or media (4).

50. A kit according to the preceding claim, characterized in that it includes a plurality of different liquids.

51. A kit according to claim 49 or claim 50, characterized in that the or each liquid is packaged in a single-use container (12).

52. A kit comprising:
a medium (4) for being impregnated with a liquid and for being applied to the human body, the medium comprising at least 80% by weight of a superabsorbent material that forms a gel on absorbing the liquid; and
the liquid for gelling said medium.

53. A medium (4) in sheet form for being impregnated with a liquid and for being applied to the human body, the medium comprising at least 80% by weight of a superabsorbent material other than polyvinylalcohol and forming a gel on absorbing the liquid.

54. An applicator comprising:
a tube (19) filled with at least one liquid; and
an applicator element (20) for impregnating by the liquid(s) contained in the tube and for being applied to the human body, the applicator element comprising a superabsorbent material.

55. A cosmetic treatment method comprising the following steps:
impregnating a medium (4) comprising at least 80% by weight of a superabsorbent material other than poly-vinylalcohol with a liquid, the medium forming a gel on absorbing the liquid; and
putting a surface to be treated into contact with the gelled medium (4).

56. A cosmetic treatment method comprising the following steps:
pouring a liquid into the housing (3) of a device (1) as defined in any one of claims 1 to 43 in order to impregnate the medium (4); and
putting a surface that is to be treated into contact with the medium (4) as impregnated in this way.
